(19) United States
(12) Patent Application Publication
(10) Pub. No.: US 2004/0124560 A1
(43) Pub. Date: Jul. 1, 2004

(54) Dual profile molding

(75) Inventors: Jason Wolter Klein, Lincoln, NE (US); Douglas Bruce Wood, Lincoln, NE (US)

Correspondence Address: Roger D. Emerson, Esq., BROUSE McDOWELL, 500 First National Tower, Akron, OH, 44308-1471, US

(73) Assignee: The Goodyear Tire & Rubber Company

(21) Appl. No.: 10/693,026

(22) Filed: Oct. 23, 2003

Related U.S. Application Data
(60) Provisional application No. 60/437,539, filed on Dec. 31, 2002.

(51) Int. Cl. B29C 35/00

(52) U.S. Cl. 264/326; 156/140; 264/161; 264/162

(57) ABSTRACT

Method for producing a power drive belt having drive teeth on both sides of the belt. The teeth include abrasion resistant facing fabric on both sides of the belt. The power drive teeth are molded on both sides of the belt slab in a planar mold having power teeth-forming recesses in first and second mold halves. In a preferred method, a portion of the belt is transfer molded by pressing tooth stock material through the cord layer and another portion of the belt is compression molded. The mold is provided with edge channels and/or waste pockets to accommodate excess tooth forming material generated during the molding process.

### BACKGROUND OF THE INVENTION

A. Field of Invention

This invention pertains to the art of methods and apparatuses of elastomeric belts and more particularly to producing dual belts wherein the teeth or grooves on both sides of the belt are overlaid with facing fabric.

B. Description of the Related Art

Synchronous power transmission belts transmit power by engagement of teeth on the belt to tooth spaces on a sprocket. When the teeth on the belt are molded from elastomeric material they often include a facing fabric overlaying the surface of the molded teeth. The fabric layer improves the wear resistance, stiffness and frictional properties of the tooth and increases the power capacity of the belt. Dual synchronous power transmission belts are belts that have teeth or grooves on both sides of the belt. They are used where one or more driven sprockets must rotate in the opposite direction to the driving sprocket. Teeth can sometimes also be formed on the belt by grinding or milling tooth spaces in a layer of elastomeric material, but said teeth do not have a facing fabric layer. Some synchronous belts, such as those of U.S. Pat. No. 5,209,705 have tooth arrangements which cannot be easily ground or milled.

Synchronous power transmission belts must have tooth spaces which are accurately formed and which are placed at an accurate distance from the neutral plane of the belt tensile member so that the teeth will properly mesh with the sprockets. This requirement applies to teeth on both sides of dual synchronous power transmission belts.

Synchronous power transmission belts with teeth on one side can be made by applying layers of belt materials to the circumference of a cylindrical mold which has cavities for forming the belt teeth. The first layer is usually a tooth facing fabric. The fabric may be applied as a stretchable cylindrical layer which is made to conform to the profile of the tooth forming cavities during molding of the belt. Alternatively, the fabric may be preformed to the profile of the tooth forming cavities, in which case the tooth forming elastomer may also be preformed to fill the tooth forming cavities prior to the addition of other layers of belt materials. In each case, the thickness and perimeter of the layers already applied to the mold must support the tensile member layer at the proper distance from the mold.

The tensile member layer is applied by helical winding of cords or wires around the mold. Additional layers of elastomer and fabric are applied after the cord. When the tooth forming cavities have not been pre-filled with elastomer, some of these materials flow between the tensile cords during molding to form the belt teeth. The thickness of the materials remaining above the tensile member does not affect the accurate forming of the teeth at the required distance from the neutral plane of the tensile member. Likewise, the variation of the thickness of each layer applied after the tensile member does not affect the accurate forming of the teeth at the required distance from the neutral plane. The proper amount of materials flows between the cords to form the teeth and any surplus or shortage of material remains on the back side. The amount of material applied after the tensile member can be increased by the anticipated variation in thickness to prevent shortage of material. Any excess material can be removed by grinding or milling after the belt is formed.

Synchronous power transmission belts with teeth on both sides must have the teeth on each side placed at the required distance from the neutral plane of the tensile member. When the teeth on the back side are ground or milled, the variation in thickness of the material applied after the cord affects only the amount of material removed, not the distance from the milled tooth to the neutral plane of the cord. This reliable process cannot be used when the back side teeth include tooth facing fabric.

It is desirable to provide a dual synchronous power transmission belt having molded teeth on both sides wherein the teeth are covered by a facing fabric and where the teeth on both sides are placed accurately with respect to the neutral plane.

The present invention provides methods and apparatuses for forming a belt having molded teeth, at an accurate distance from the neutral plane, on both sides of the belt and for providing facing fabric overlying the teeth.

### SUMMARY OF THE INVENTION

According to one aspect of the present invention, a method for forming a dual synchronous power transmission belt is provided. The belt is formed in a press having a heatable first mold half and a heatable second mold half. The method comprises the steps of:

providing first teeth-forming recesses in the first mold half and providing second teeth-forming recesses in the second mold half;

providing waste pockets in the first, or second, or both mold halves;

building a belt slab comprising a tensile member material and tooth forming material positioned between first and second layers of tooth facing fabric;

positioning the belt slab between the first and second mold halves; and,

forcing the tooth forming material into the tooth-forming recesses in the first and second mold halves by decreasing a distance therebetween to a predetermined distance whereby the first layer of facing fabric is pushed into the teeth-forming recesses in the first mold half ahead of the tooth forming material and the second layer of facing fabric is pushed into the teeth-forming recesses in the second mold half ahead of the tooth forming material, with excess material flowing into the waste pockets.

According to another aspect of the invention, the method includes positioning a cord layer between the first and second layers of tooth facing fabric.

According to another aspect of the invention, the method includes positioning a barrier layer between the first and second layers of tooth facing fabric.

According to another aspect of the invention, the method includes positioning a cord layer between the first and second layers of tooth facing fabric and adjacent to the first layer of tooth facing fabric; and, positioning a barrier layer between the first and second layers of tooth facing fabric and adjacent to the cord layer.

According to another aspect of the invention, the method includes forcing a first amount of the tooth stock material to flow through the barrier layer and through the cord layer and into the first teeth-forming recesses; and, forcing a second amount of the tooth stock material to flow into the second teeth-forming recesses without passing through the cord layer.

According to another aspect of the invention, the method includes forcing a first amount of the tooth stock material to flow through the barrier layer and through the cord layer and into the first teeth-forming recesses; and, forcing a second amount of the tooth stock material to flow into the second teeth-forming recesses without passing through the cord layer, and, forcing excess material to flow into waste pockets.

According to another aspect of the invention, the method includes forcing excess material to flow through the face fabric or barrier material and into waste pockets.

According to another aspect of the invention, the method includes forcing face fabric or barrier material to flow with the excess tooth forming material into waste pockets.

According to another aspect of the invention, there is provided a dual synchronous power transmission belt formed according to the inventive methods disclosed herein.

### BRIEF DESCRIPTION OF THE DRAWINGS

The invention may take physical form in certain parts and arrangement of parts, a preferred embodiment of which will be described in detail in this specification and illustrated in the accompanying drawings which form a part hereof and wherein:

FIG. 1 sectional view of an open molding apparatus and an unformed, uncured belt slab according to the present invention;

FIG. 2 is sectional view of a closed molding apparatus and a molded belt slab according to the present invention;

FIG. 3 is a side view of a belt formed according to the present invention;

FIG. 3A is an expanded view of a portion of the belt shown in FIG. 3;

FIG. 4 is a side view of a mold half showing edge channels;

FIG. 5 is a side views of a mold half showing waste pockets;

FIG. 6 is a perspective view illustrating another embodiment for the arrangement of waste pockets; and, FIG. 7 is a perspective view of a mold half having helical teeth.

### DESCRIPTION OF THE PREFERRED EMBODIMENT

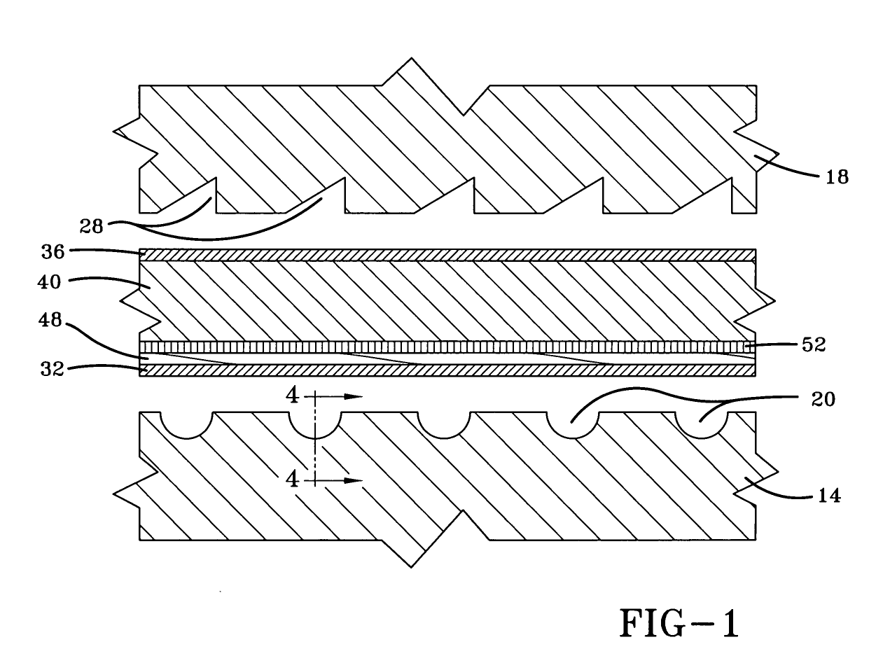

Referring now to the drawings wherein the showings are for purposes of illustrating a preferred embodiment of the invention only and not for purposes of limiting the same, FIG. 1 shows a belt slab 10 positioned between a first mold half 14 and a second mold half 18 prior to molding any teeth in the belt slab 10. The first and second mold halves 14, 18 are heatable by an associated heating means as known to those having skill in the art.

The first mold half 14 comprises teeth-forming recesses 20 therein of a predetermined shape. The teeth formed in the first side of the belt slab may have any desired cross-sectional shape such as trapezoidal, curvilinear, curvilinear-truncated. The teeth may be formed transverse to the length of the belt or offset by a predetermined angle. Also, the teeth may be arranged into tracks of teeth to form two or more finished belts. The recesses 20 first mold half 14 therefore are machined to accommodate the desired finished tooth appearance.

The second mold half 18 also comprises teeth-forming recesses 28 therein of a predetermined shape. The teeth formed in the second side of the belt slab may also have any desired cross-sectional shape. The shape of the teeth on the second side of the belt may be similar to the teeth on the first side of the belt but it is within the scope of the present invention to provide unmatched teeth on either side of the belt.

In the preferred embodiment, the belt slab 10 includes a first layer of facing fabric 32 and a second layer of facing fabric 36. The preferred fabrics include nylon, and other facing fabrics known in the art. Tooth stock material 40 is positioned between the first and second layers of facing fabric 32, 36. As the belt teeth are molded, the tooth stock material 40 flows into the teeth-forming recesses 20, 28 and pushes the first and second layers of facing fabric 32, 36 into the recesses 20, 28. Therefore, when the belt is molded and cured, it includes teeth on both sides and those teeth are covered with facing fabric.

In the preferred embodiment, the belt slab 10 also includes a cord layer 48. In the preferred embodiment, the cord layer 48 is positioned between the first and second layers of facing fabric 32, 36 and adjacent to the first layer of tooth facing fabric 32. Therefore, in the preferred embodiment, only one layer of tooth stock material 40 is present in the belt slab 10. For the purposes of the present invention, “layer” means a discrete area of the chosen material. Therefore, a “layer” of tooth stock material 40, as described and claimed, may actually encompass more than a single ply of material, but the material is plied in an adjacent manner in the belt slab 10 to form one “layer.” Likewise, a “layer” of facing fabric 32 or 36 may actually encompass one or more plies of fabric.

In the preferred embodiment, the belt slab 10 may further comprise a barrier layer 52. The barrier layer 52 is positioned between the first and second layers of tooth facing fabric 32, 36 and adjacent to the cord layer 48. Alternatively, the barrier layer 52 may be placed within the tooth forming layer 40 (not shown).

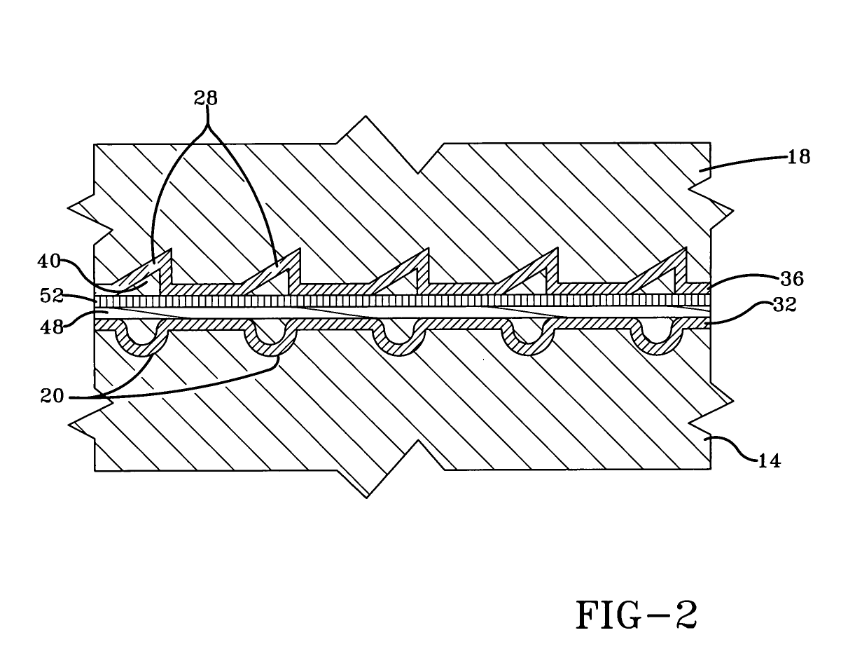

FIG. 2 is directed to the belt slab 10 during the molding process. The distance between the first mold half 14 and the second mold half 18 is decreased to a predetermined distance. As shown in FIG. 2, the teeth-forming recesses 20, 28 are occupied by the first and second layers of facing fabric 32, 36 and tooth stock material 40. In the preferred embodiment, when the belt is molded, the cord 48 is contact with the first face fabric 32 between the tooth cavities 20.

A comparison of the unmolded belt slab 10 shown in FIG. 1 with the belt slab 10 shown in FIG. 2 illustrates the changed position of portions of the tooth stock material 40. A first portion of the tooth material 40 passes through barrier layer 52 and through cord layer 48 in order to fill the first teeth-forming recesses 20 in the first mold half 14. This process is known as “transfer molding” in the art since a portion of the tooth material 40 is transferred from one side of the cord layer 48 to the other in the molding process. Transfer molding is described in U.S. Pat. No. 5,733,399, the entire contents of which are hereby incorporated herein by reference.

However, another portion of the tooth material 40 is forced into the teeth-forming recesses 28 in the second mold half 18 without passing through the cord layer 48. This process is known in the art as “compression molding.” Therefore, as shown in FIG. 2, when the belt slab 10 is molded a portion of the tooth material is subjected to transfer molding and another portion of the tooth material 40 is subjected to compression molding. Although FIG. 2 shows the first mold half 14 as being a lower mold half, such arrangement is merely for clarity and convenience and not by way of limiting the present invention.

Also, in FIGS. 1 and 2, the teeth-forming recesses 20 in the first mold half 14 are illustrated as having a different shape than the teeth-forming recesses 28 and the second mold half 18. Again, this representation is for ease of illustration and not by way of limiting the invention. It is within the scope of the present invention to include identical teeth-forming recesses 20, 28 in each mold half 14, 18 or the teeth-forming recesses 20, 28 can be different depending on the desired application.

With reference to FIG. 2, the teeth-forming recesses 20 and the first mold half 14 are shown to be substantially aligned with the teeth-forming recesses 28 in the second mold half 18. This representation is merely for the ease of illustration and is not meant to limit the invention. The teeth-forming recesses 20 in first mold half 14 may be substantially aligned with the teeth-forming recesses 28 in second mold half 18, they may be substantially offset, or staggered by any desired offset distance.

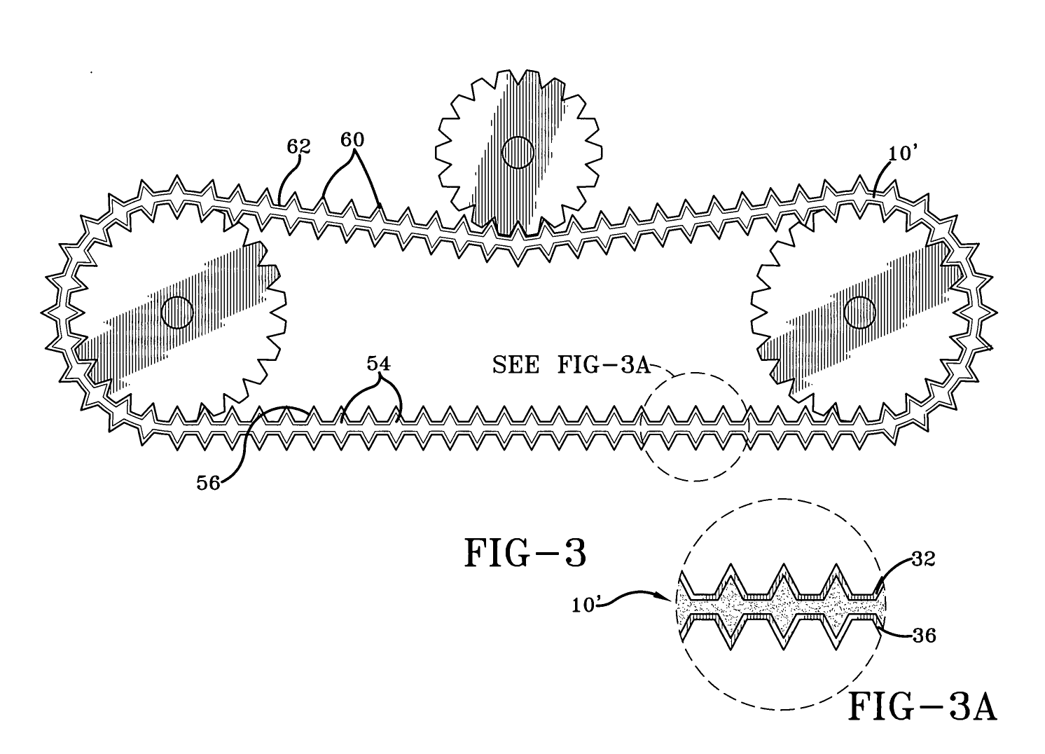

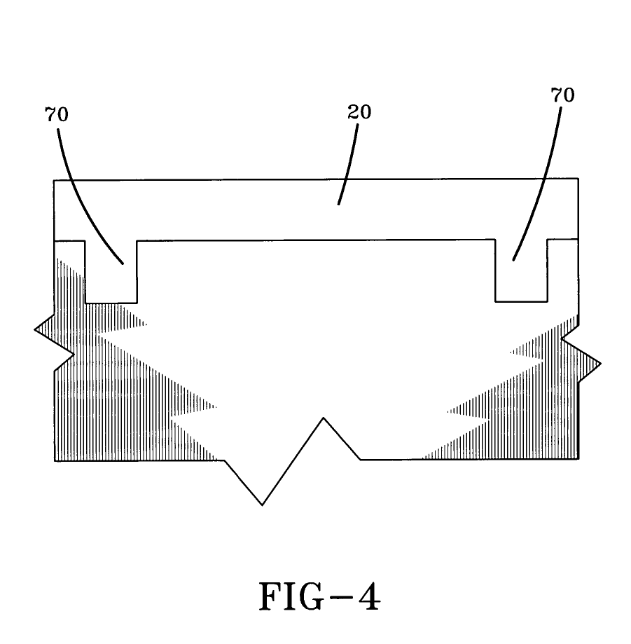

FIG. 3 illustrates one embodiment of a belt 10′ formed according to the methods of the invention. The belt includes inner teeth 54 disposed on an inner periphery 56 of the belt 10′ and outer teeth 60 disposed along the outer periphery 62 of the belt 10′. In that way, both sets of teeth may be utilized for various timing applications. In accordance with the present invention, the inner teeth 54 and outer teeth 60 each comprise facing fabric 32, 36, shown in greater detail in FIG. 3A. Therefore, both sets of teeth are resistant to abrasion.

The preferred method of forming a dual power belt includes forming the belt in a press having a heatable first mold half 14 and a heatable second mold half 18. The first mold half 14 is provided with power teeth-forming recesses 20 therein for forming teeth on one side of the belt. The second mold half 18 is provided with power teeth-forming recesses 28 therein for forming teeth on the other side of the belt. A belt slab 10 is built so that tooth stock material 40 is positioned between first and second layers of tooth facing fabric 32,36. The belt slab 10 is positioned between the first and second mold halves 14,18. The distance between the mold halves 14, 18 is decreased to a predetermined distance so that the tooth stock material 40 is forced into the teeth-forming recesses in the first and second mold halves 14, 18. In this process, the first layer of facing fabric 32 is pushed into the power teeth-forming recesses 20 in the first mold half ahead of the tooth stock material 40 and the second layer of facing fabric 36 is pushed into said power teeth-forming recesses 28 in the second mold half 18 ahead of the tooth stock material 40. Therefore molded teeth, covered with facing fabric, are formed into both sides of the belt.

The preferred method disclosed above is directed to a single mold as is known in the art. It is within the scope of the invention to simultaneously mold two sections of the belt using stacked molds and platens as known in the art.

As discussed above, in prior art dual belts, the teeth are ground into the backside of the belt after the molding process is complete. At that time, excess belt material can also be ground off. However, such grinding would defeat the purposes of the present inventive dual profile molding. Therefore, the volume of tooth stock material 40 to be molded must either be precisely calculated and controlled, or means of accommodating excess material must be provided.

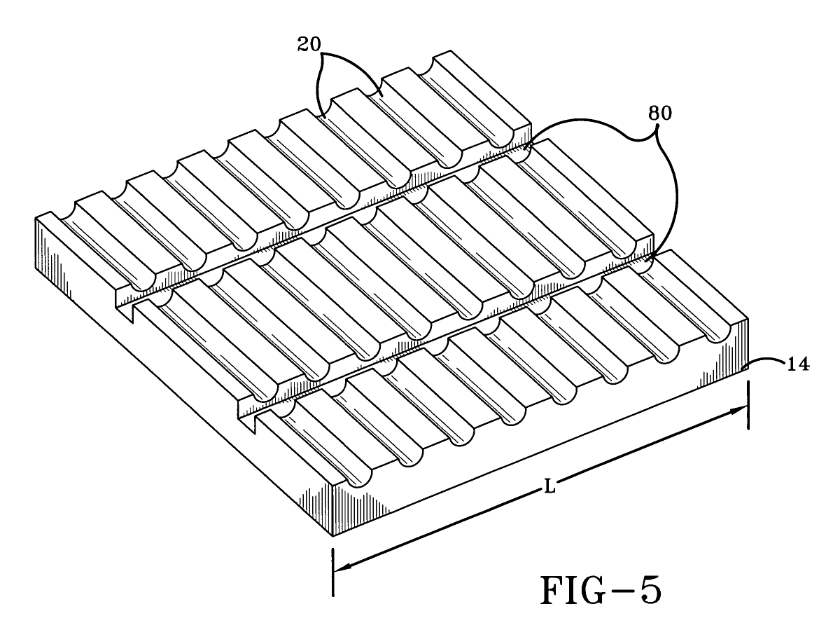

In a preferred embodiment, shown in FIG. 4, excess tooth stock material flows toward the edges of the mold and is collected in edge waste pockets 70. In a preferred embodiment, one or both of the mold halves is preferably designed with one or more edge waste pockets 70 for collecting excess tooth stock material. Such an embodiment would suffice for narrow molds for forming a small number of individual belts from a single molded belt slab. In a preferred embodiment, the edge waste pockets 70 intersect with tooth forming recesses 20 and are disposed to run with the length of the molded belt.

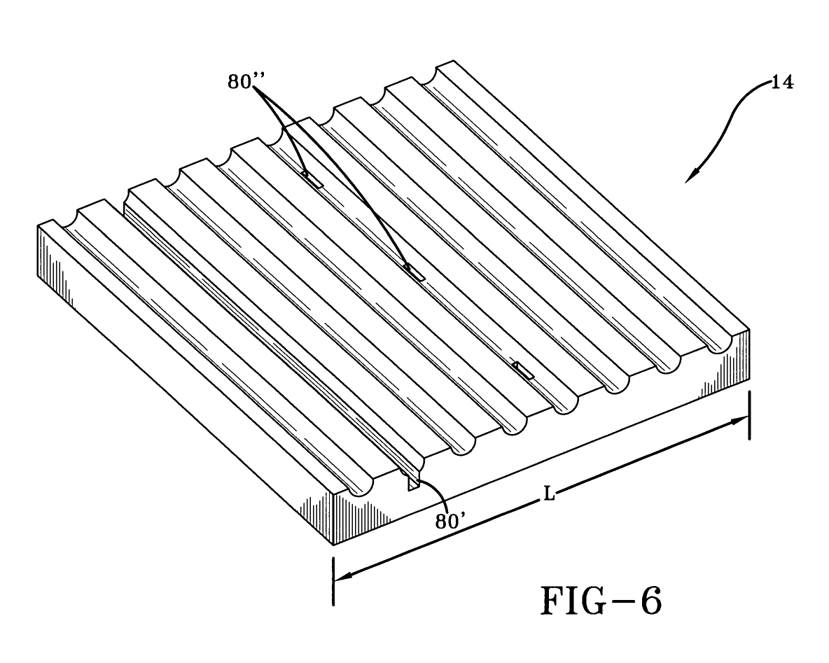

When a wider mold is utilized to provide, for example, a plurality of timing belts from a single molding operation, merely allowing excess tooth stock material to flow to the outermost edges of the mold may not accomplish the desired results. Therefore, the present invention encompasses other means of accommodating excess tooth stock material. For example, one embodiment shown in FIG. 5 shows a mold half having a plurality of waste-pockets 80. In a preferred embodiment, there is provided a plurality of waste pockets 80 as continuous grooves along the length, L, of the mold and intersecting with the tooth forming cavities 20. The portions of the belt slab formed between the waste pockets 80 will correspond to molded belts having accurate shape and thickness. The portion of the belt slab including excess material that has flowed into waste pockets 80 is discarded when individual belts are cut from the molded belt slab. The waste pockets 80 can be positioned in one or both mold halves. In addition, the mold halves 14, 18 may include both edge waste pockets 70 and waste pockets 80 as needed.

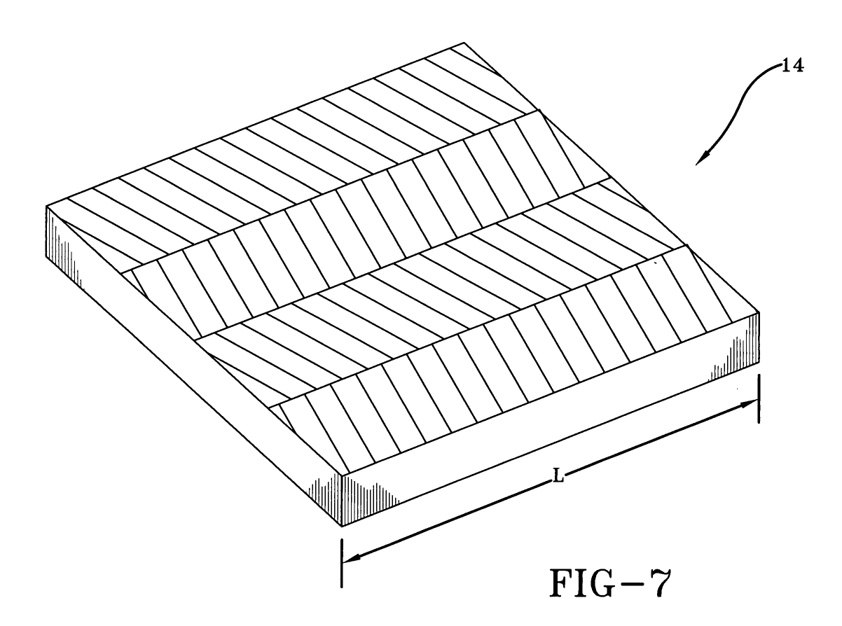

FIG. 6 illustrates optional embodiments for the arrangement of waste pockets. In another preferred embodiment, the waste pockets 80′ are placed at the bottom of the tooth forming recesses 20 and/or 28. The waste pockets 80′ are formed as continuous channels with sufficient volume to accommodate excess tooth forming material 40 and are shaped to resist flow of tooth forming material 40 and facing fabric 32 and/or 36 into the waste pockets 80′ until the tooth is fully formed. Excess material is thus molded to the outermost surface of the belt tooth where it can be removed by grinding or milling after the belt is molded. The entire width of the belt slab can thus be cut into individual belts of arbitrary width. Also shown in FIG. 6 are waste pockets 80″ which are intermittently spaced in the tooth forming recesses. These intermittent waste pockets 80″ operate in a similar manner to the waste pockets 80 shown in FIG. 5. The waste pockets 80″ may be removed by grinding, milling or other means for deflashing after the belt is cured. Further, the entire width of the belt slab can thus be cut into individual belts of arbitrary width.

In one preferred embodiment, the belt slab 10 is formed into a cylinder prior to being molded.

The inventive method disclosed herein may also be adapted for use with single-sided toothed belts. The belt would be molded in a mold with only one half having tooth forming recesses therein. However, the belt would be molded to a predetermined thickness by accommodating any excess through means disclosed in the present application. As discussed above, prior art applications require grinding the back of the belt after molding. Use of the inventive method to accommodate excess tooth material, even in single-sided belts, eliminates the need to grind the belt to a predetermined thickness. Therefore, the belt can be molded with a backing fabric on the flat, untoothed surface.

In yet another preferred embodiment, shown in FIG. 7, the tooth forming recesses in one or both mold halves are adapted to formed helical teeth in the molded belt. The mold may include the above described edge waste pockets 70 or any of the embodiments of waste pockets 80, 80′, 80″.

The preferred embodiments have been described, hereinabove. It will be apparent to those skilled in the art that the above methods may incorporate changes and modifications without departing from the general scope of this invention. It is intended to include all such modifications and alterations in so far as they come within the scope of the appended claims or the equivalents thereof.

Having thus described the invention, it is now claimed:

I/we claim:

1. A method for forming a dual power belt in a press having a heatable first mold half and a heatable second mold half, the method comprising the steps of:
providing first teeth-forming recesses in said first mold half and providing second teeth-forming recesses in said second mold half;
building a belt slab comprising tooth forming material positioned between first and second layers of tooth facing fabric;
positioning said belt slab between said first and second mold halves; and,
forcing said tooth forming material into said tooth-forming recesses in said first and second mold halves whereby said first layer of facing fabric is pushed into said teeth-forming recesses in said first mold half ahead of said tooth stock material and said second layer of facing fabric is pushed into said teeth-forming recesses in said second mold half ahead of said tooth stock material.

2. The method of claim 1 wherein the step of building a belt slab further comprises:
positioning a cord layer between said first and second layers of tooth facing fabric.

3. The method of claim 1 wherein the step of building a belt slab further comprises:
positioning a barrier layer between said first and second layers of tooth facing fabric.

4. The method of claim 1 wherein the step of building a belt slab further comprises:
positioning a cord layer between said first and second layers of tooth facing fabric and adjacent to said first layer of tooth facing fabric; and,
positioning a barrier layer between said first and second layers of tooth facing fabric and adjacent to said cord layer.

5. The method of claim 4 wherein the step of forcing said tooth stock material into said teeth-forming recesses in said first and second mold halves comprises:
forcing a first portion of said tooth stock material to flow through said barrier layer and through said cord layer and into said first power teeth-forming recesses; and,
forcing a second portion of said tooth stock material to flow into said second power teeth-forming recesses without passing through said cord layer.

6. The method of claim 1 wherein said step of building a belt slab comprises forming said belt slab into a cylinder prior to said step of positioning said belt slab.

7. The method of claim 1 further comprising the step of:
providing means for accommodating excess tooth stock material.

8. The method of claim 7 wherein said step of providing means for accommodating excess tooth stock material includes providing an edge channel in said first mold half.

9. The method of claim 7 wherein said step of providing means for accommodating excess tooth stock material includes providing a waste pocket is said first mold half.

10. A method for forming a dual power belt comprising the steps of:
building a belt slab comprising tooth stock material positioned between first and second layers of tooth facing fabric;
forming a first set of power drive teeth on a first side of said belt slab wherein said first set of power drive teeth comprise said first layer of tooth facing fabric; and,
forming a second set of power drive teeth on a second side of said belt slab wherein said second set of power drive teeth comprise said second layer of tooth facing fabric.

11. A method for forming a dual power belt comprising the steps of:
providing first teeth-forming recesses in said first mold half and providing second teeth-forming recesses in said second mold half;
providing waste pocket in said first mold half;
building a belt slab comprising first and second layers of tooth facing fabric and a tensile member and tooth forming material positioned between said first and second layers of tooth facing fabric, said tooth forming material having a volume sufficient to fill said first and second teeth-forming recesses and generating excess material;
positioning said belt slab between said first and second mold halves; and,
forcing said tooth forming material into said tooth-forming recesses in said first and second mold halves by decreasing a distance therebetween to a predetermined distance whereby said first layer of facing fabric is pushed into said teeth-forming recesses in said first mold half ahead of said tooth forming material and said second layer of facing fabric is pushed into said teeth-forming recesses in said second mold half ahead of said tooth forming material; and
accommodating said excess material in said waste pocket.

12. A dual power belt formed according to the method of claim 1.

13. A method for forming a synchronous drive belt comprising the steps of:
providing first teeth-forming recesses in said first mold half;
providing a second mold half;
providing waste pocket in said first mold half;
building a belt slab comprising first and second layers of tooth facing fabric and a tensile member and tooth forming material positioned between said first and second layers of tooth facing fabric, said tooth forming material having a volume sufficient to fill said first and second teeth-forming recesses and generating excess material;
positioning said belt slab between said first and second mold halves; and,
forcing said tooth forming material into said tooth-forming recesses in said first mold half by decreasing a distance between said first and second mold halves to a predetermined distance whereby said first layer of facing fabric is pushed into said teeth-forming recesses in said first mold half ahead of said tooth forming material; and
accommodating said excess material in said waste pocket.

14. The method of claim 13, further comprising the steps of:
deflashing said excess material after said belt has cured.

15. The method of claim 14, wherein the step of deflashing said excess material after said belt has cured includes grinding said waste pocket.

16. The method of claim 14, wherein the step of deflashing said excess material after said belt has cured includes millig said waste pocket.
